(19) United States
(12) Patent Application Publication
(10) Pub. No.: US 2005/0098361 A1
(43) Pub. Date: May 12, 2005

(54) Current powered vehicle

(76) Inventor: Walter Mitchell, Stone Mountain, GA (US)

Correspondence Address: TECHNOPROP COLTON, L.L.C., P O BOX 567685, ATLANTA, GA, 311567685, US

(21) Appl. No.: 10/706,592

(22) Filed: Nov. 12, 2003

(51) Int. Cl. B60L 8/00

(52) U.S. Cl. 180/2.2

(57) ABSTRACT

A power system for powering a vehicle having an airflow or waterflow channeling device mounted on the vehicle, a laterally mounted fan unit, and an electric alternator connected to the fan unit, in which airflow or waterflow spins the laterally mounted fan thus generating electricity via the electric alternator to power the vehicle.

### BACKGROUND OF THE INVENTION

1. Technical Field

The present invention generally is related to devices for powering vehicles such as automobiles, trucks, boats, trains, airplanes or other vehicles, and more particularly is related to device for using air or water current to power a vehicle and produce vehicle movement through the use of fan blades, turbine blades, squirrel cage fans and the like attached to an electric alternator for producing electricity to power an electric motor for powering the vehicle.

2. Prior Art

Over the past century, air pollution has become an ever-increasing problem, especially in the area around and in large cities. The greenhouse gases and other poisons that are created by gasoline-driven and other fossil fuel-powered vehicles pose a serious threat to the life expectancy of humans, other living inhabitants of the Earth, and even the Earth itself. The automobile and other vehicles are considered major factors in creating this problem of air pollution. In fact, air pollutants are thought to be one of the main causes of lung cancer, emphysema, heart disease, serous eye trouble, and other ailments. Some studies have estimated that more than 80 percent of air pollution found in areas around major cities is attributable to gasoline-powered vehicles. Non-polluting alternatives to such dirty fuels are desirable.

The availability and cost of fossil fuels is in constant flux. One week, the price of a gallon of gasoline may be within one's budget, and the next week, it may not be. Further, although gasoline stations are relatively ubiquitous, especially in the United States, there still are locations where gasoline is not available, including in the air for flying vehicles and on bodies of water for floating vehicles. Free, low-cost, and readily available alternatives to gasoline are desirable.

Various attempts to reduce or eliminate the air pollution problem associated with the noxious and poisonous fumes emanating from gasoline-powered vehicles have not been completely successful. For example, in recent decades, there has been a substantial interest and experimentation in electrically powered vehicles. While the concept of electric vehicles, such as electric and electric/gasoline hybrid automobiles, has been known for decades, the method or system for providing power to run such vehicles or to at least charging the batteries of such vehicles has been elusive. The size limitation and the limited electrical capacities of the batteries also have severely limited the cruising range of such vehicles. Thus, more effective methods for charging the batteries are needed.

To charge or supplement the power of a vehicle's alternator, the prior art discloses the use of wind turbines. For example, U.S. Pat. No. 3,444,946 to Waterbury discloses an electric powered vehicle that is powered through an array of batteries arranged in series that is powered through either wind power and/or solar power. In Waterbury '946, the wind power system is used to power each wheel of the automobile separately through the use of multiple batteries and multiple wind generation systems. For another example, U.S. Pat. No. 4,314,160 to Boodman discloses a means to provide electrical power to a vehicle. In Boodman '160, an air scoop is mounted to the top of vehicle and a turbine wheel is mounted in the rear of the air scoop. An electric alternator is connected to the turbine wheels so that air passing through the air scoop will generate additional electricity for the vehicle batteries.

Accordingly, there is always a need for a system to improve the ability to electrically power a vehicle, and/or to charge or supplement the charge of a vehicle's batteries to allow the vehicle to operate without the use of gasoline or other additional fuels. There is also a need for such a system to make use of the wind force that arises from driving a vehicle and/or the natural winds and air currents. The present invention is directed to these needs and others.

### BRIEF SUMMARY OF THE INVENTION

The present invention is an air- or water-power system that can charge or maintain the charge on a vehicle battery and that can provide electricity to operate an electric motor for running a vehicle. The power system provides a means for electricity generation while the vehicle is in motion by using either or both of the naturally occurring air or water currents and/or the relative air or water currents generated by the vehicle when in motion. Broad-bladed horizontal fan blades laterally extending across the vehicle are used to catch the current and to transfer the current's energy to electrical alternators. This electricity ultimately provides power to the vehicle as the electricity is provided directly to the electric motor that powers the vehicle, or is provided to charge the batteries, which are connected to the motor that powers the vehicle. The power system is used to convert mechanical airflow or waterflow energy into electrical energy to power the useful features of the vehicle and/or to supplement the power supply for the vehicle. As such, the power system can be used to improve the efficiency of an array of vehicles, including electric-powered vehicles, hybrid electric and gasoline-powered vehicles, and gasoline-powered vehicles.

In one embodiment, the power system comprises at least one and preferably two or more fan units with fan blades, at least one and preferably two or more electric generators or alternators (both of which are referred to in this specification as alternator) associated with and powered by each fan unit, and electric wiring connecting the alternators to the vehicle's motor or to the vehicle's batteries for operating the vehicle's motor. The system also can comprise a means for covering or closing off access to the system from airflow or waterflow for parking, storage, or if a hybrid electric/gasoline engine is in use in the gasoline-only mode. The system also can comprise a funnel mounted on the vehicle for directing more air or water towards the fan blades.

Preferably, there are two or more fan units positioned one behind the other on the vehicle, or at some other relatively open location proximal to the air or water currents. For a land or air vehicle, a suitable location is on the top of the vehicle. For a water vehicle, a suitable location for an airflow embodiment is on the top of the vehicle and a suitable location for a waterflow embodiment is on the vehicle below the water line. Although the two fan units can lie in the same horizontal plane, the rear fan unit can be positioned above the fore fan unit so as to form a wedge-like configuration. More specifically, in the airflow embodiment, the second of the two fan units is arranged higher from roof than the first of the two fan units. Preferably, the wedge faces the front of the vehicle, as this configuration is more efficient in harvesting the currents. Specifically, this configuration is advantageous in that it provides for a more aerodynamic and hydrodynamic shape to the power system and as such is able to lower the added drag force of the power system on the vehicle. If three or more fan units are used, this wedge configuration can be continued relative to the third and rearmost fan unit.

In operation and use, the airflow or waterflow spins the fan blades and the spinning fan blades turn the electric alternators to produce electrical energy for the vehicle. When the vehicle is in motion, the relative airflow or water flow generated by the motion of the vehicle produces greater flow across the fan blades as the air or water travels across the fan unit. As the airflow or water flow presses against the surface of the fan blade, the fan units rotate about an axis, thus rotating the fan unit, which in turn turns the electric alternators. The electrical energy produced by the alternators can be transferred directly to the vehicle's engine to power the vehicle directly, or can be transferred to the vehicle's batteries so to recharge, charge, or supplement the power of the batteries.

The vehicle can be parked facing into the direction of the air or water currents so to provide a means for charging, recharging, or supplementing the charging batteries while the vehicle is parked. In this embodiment, the placement of the vehicle facing into the current allows the fan units to be turned by the currents when the vehicle is parked. More particularly, as the air or water flows across the fan units, the fan units spin, turning the electric alternators, thus converting the airflow or waterflow's mechanical energy into electrical energy. In an alternative embodiment, the generated power can be used to power other electrical systems or components of the vehicle. Thus, the fan units provide a means for providing electricity for useful functions when the engine is not in use.

Another feature of the present invention is that it can allow a vehicle to run without the use of carbon-based fuels, thereby decreasing the pollution emitted from the vehicle. By incorporating such an invention into a vehicle, it may be possible to reduce the emissions of a vehicle without comprising the general performance of the vehicle.

These features and other features, objects and advantages of the present invention will become more apparent to those of ordinary skill in the relevant art when the following detailed description of the preferred embodiments is read in conjunction with the appended drawings in which like reference numerals designate like components throughout the several views.

### BRIEF DESCRIPTION OF THE DRAWINGS

FIG. 1 is perspective view showing a vehicle with an embodiment of the present invention installed thereon.

FIG. 2 is a cross-sectional view of the present invention showing the primary components of the invention.

FIG. 3 is side view of a fan unit showing the design of a blade.

FIG. 4 is front view of the fan blade unit component of the present invention.

FIG. 5 is a side view of the embodiment of the invention shown in FIG. 1 showing a flat design.

FIG. 6 is a side view of the embodiment of the invention shown in FIG. 1 showing a wedge design.

FIG. 7 is front view of the embodiment of the invention shown in FIG. 1 showing a flat design.

FIG. 8 is front view of the embodiment of the invention shown in FIG. 1 showing a wedge design.

FIG. 9 is a side view of an embodiment of the invention mounted on a watercraft.

FIG. 10 is a side view of an alternate embodiment of the invention showing an over-under design.

FIG. 11 is a front view of the embodiment of the invention shown in FIG. 10.

FIG. 12 is a side view of another alternate embodiment of the invention showing an alternate structure for the fan blades.

FIG. 13 is a front view of the embodiment of the invention shown in FIG. 12.

FIG. 14 is a side view of an alternate embodiment of the invention mounted on a watercraft.

FIG. 15 is a side view of an embodiment of the invention mounted on a train.

### DETAILED DESCRIPTION OF THE PREFERRED EMBODIMENTS

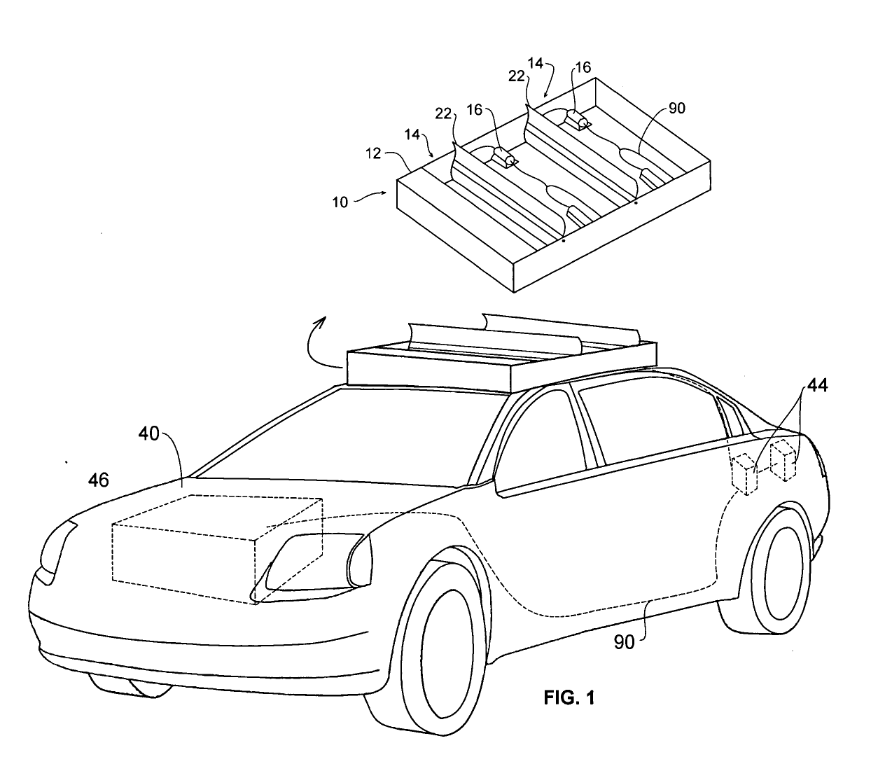

Illustrative embodiments of the power system and its components and placement on an example vehicle according to the present invention are shown in FIGS. 1 through 15. Although vehicle 40 as shown in the figures is an automobile, watercraft or train, it is understood that power system 10 may be used or installed on any vehicle, including trucks, trailers, aircraft and the like. Further, while power system 10 primarily is shown to be on the top or roof of vehicle 40, it is understood that power system, or various components thereof such as fan units 14 can be on the sides of vehicle 40. While the invention is described herein in conjunction with the exemplary and preferred embodiments, it will be understood that the invention is not limited to these embodiments.

Referring now to FIG. 1, a perspective view of one embodiment of the invention is shown installed on a landcraft. Vehicle 40 has a conventional electrically powered, a hybrid electrically/gasoline powered, or other powered engine 46 configured with power system 10. As embodied in FIG. 1, power system 10 provides a means for electricity generation while the vehicle is in motion, or while the vehicle is stopped if there is a wind or other airflow present. This electricity ultimately provides power to vehicle 40 as the electricity powers engine 46 or charges batteries 44, which are connected to motor 46, which powers vehicle 40. More particularly, power system 10 is able to convert mechanical airflow energy into electrical energy to power the useful features of vehicle 40 and/or to supplement the power supply for vehicle 40. As such, power system 10 can be used to improve the efficiency of an array of vehicles 40, including electric vehicles, hybrid electric and gasoline vehicles, gasoline vehicles. Natural gas vehicles, and indeed vehicles of any power source.

In the embodiment shown in FIG. 1, power system 10 comprises support structure 12, two fan units 14, four electric alternators 16, fan belts 18 mechanically connecting fan units 14 to electric alternators 16, and electric wiring electrically connecting electric alternators to batteries 44 and/or engine 46. Support structure 12, fan units 14 and electric alternators 16 are mounted on top of vehicle 40 and face forward with respect to vehicle 40. For a typical landcraft, this positioning is advantageous as the roof of vehicle 40 both typically is open to the wind and is out of the way.

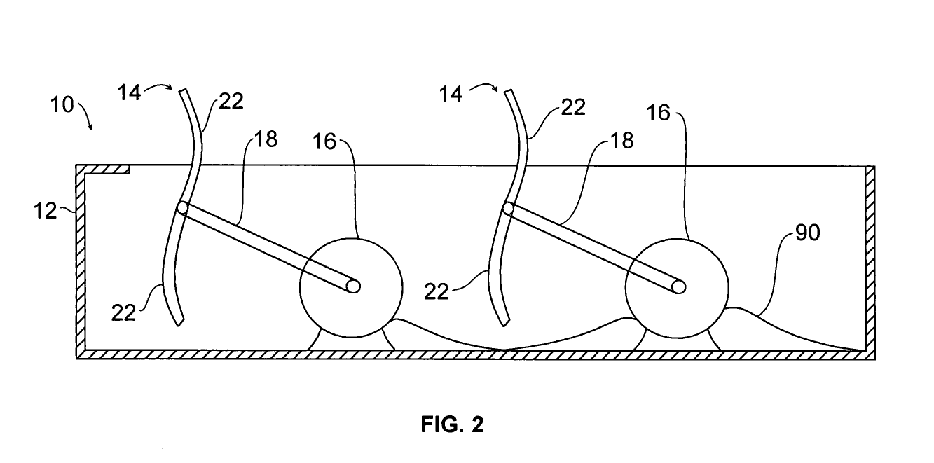

Referring now to FIG. 2, a side sectional view of one embodiment of the invention 10 is shown in more detail. Preferably there are two fan units 14 each having two electric alternators 16 associated therewith. Fan units 14 are positioned one in front of the other, with one being more proximal to the front of vehicle 40 and the other being more proximal to the rear of vehicle 40. Electric alternators 16 can be positioned anywhere within support structure 12 as long as electric alternators 16 can be mechanically connected to fan units 14. As shown in FIG. 2, electric alternators 16 are positioned immediately behind their respective fan units 14, with one electric alternator 16 being located on each side of vehicle 40. Electrical wiring connects electric alternators 16 to engine 46 and/or to batteries 44.

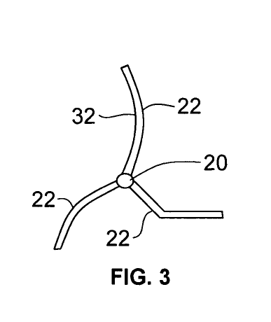

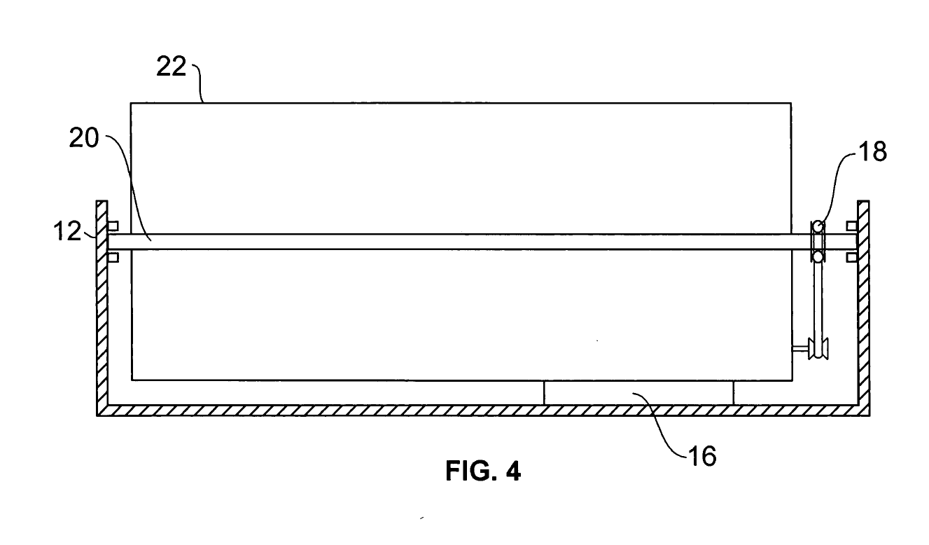

Referring now to FIG. 3, a side cross-section view of a representative fan unit 14 is shown in more detail. Fan unit 14 comprises a rod-shaped central axis 20 and projecting fan blades 22. Fan blades 22 extend axially from central axis 20, as can be seen in the front view of a representative fan unit 14 shown in FIG. 4. The combination of fan blades 22 and central axis 20 forms a paddle wheel type of structure. As shown in more detail in FIG. 4 and below, fan units 14 are mounted onto support structure 12 such that central axis is located proximal to the top of support structure 12, allowing one or more fan blades 22 to extend out of support structure 12 so as to contact the wind, while keeping one or more fan other blades 22 to remain within support structure 12 out of the wind. As the wind contacts fan blades 22 causing fan unit 14 to rotate, fan blades 22 rotate in and out of support structure 12.

Each fan blade 22 can have a slight concave surface 32 for catching the mechanical wind energy more effectively. The radius of curvature of fan blade 22 is such that air can be held on the surface of fan blade 22 long enough to increase force. Fan blades 22 also can be flat sheet-like blades, have a curve to them, or can have angled or curved ends. One of ordinary skill in the fan blade art can design fan blades 22 to be most efficient. Further, although one or two fan blades 22 can be used per fan unit 14, it is preferable for there to be three or more fan blades 22 per fan unit 14 as this will ensure that fan unit 14 will rotate continuously and not be forced into a horizontal-type position by the force of the wind. FIG. 3 shows three alternate embodiments for the structure of fan blade 22 for illustrative purposes and is not meant to be indicative of the preferred fan unit 14.

In a preferred embodiment, central axis 20 is perpendicular to a centerline extending horizontally from the front of vehicle 40 to the back of vehicle 40. In this manner, the majority of the surface area of fan blade 22 will be contacted by the airflow or water flow. Further, in a preferred embodiment, fan unit 14 comprises a plurality of fan blades 22 and fewer than the plurality of fan blades 22 are contacted by a driving force at any given time and position. In this manner, fan blades 22 rotating in the forward direction will not cause wind resistance.

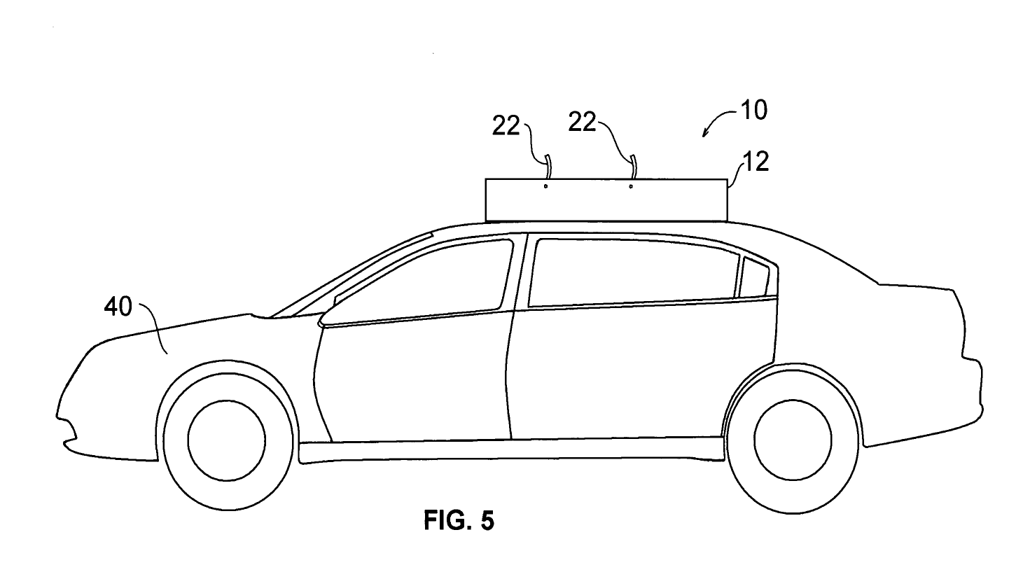

Referring now to FIG. 5, a side view of one embodiment of the invention 10 is shown showing a flat design, meaning that two or more fan units are in generally the same horizontal plane. Support structure 12 is attached to the top of vehicle 40. Fan units 14 are mounted on support structure 12 such that central axis 20 extends horizontally and laterally across vehicle 40 from one side to the other. As fan units 14 are mounted towards the top of support structure 12, one or more individual fan blades 22 extend up out of support structure 12 and can be contacted by the wind.

Electric alternators 16 are mounted within support structure 12. Although electric alternators 16 can be mounted anywhere as long as they can be mechanically connected to fan units 14, it is preferable to mount electric alternators 16 relatively close to and in a direct line from fan units 14 to minimize the mechanical linkages and to increase efficiency of the mechanical linkages. As shown, electric alternators 16 are mounted immediately behind their respective fan units 14. Fan belts 18 connect fan units 14 to electric alternators 16 in known and common configurations such that when fan units 14 rotate, the rotational energy is transferred via fan belts 18 to electric alternators 16. To increase the amount of rotational energy transferred from fan units 14 to electric alternators 16, it can be preferable to have two or more electric alternators 16 associated with each fan unit 14.

Electric wiring 90 electrically connects electric alternators 16 to either or both of engine 46 and/or batteries 44. By connecting electric alternators 16 directly to engine 46, electric alternators can power engine 46, and thus propel vehicle 40, directly. By connecting electric alternators 16 directly to batteries 44, electric alternators can charge batteries 44, and batteries 44 can be used to power engine 46.

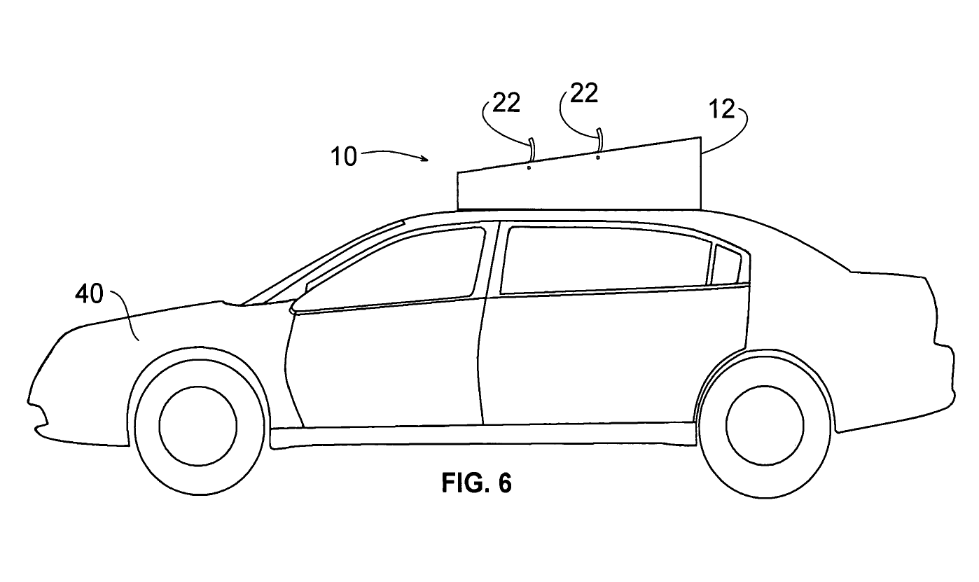

Referring now to FIG. 6, a side view of another embodiment of the invention 10 is shown showing a wedge design, meaning that two or more fan units 14 are in different horizontal planes, but preferably are in the same sloped plane relative to the top of vehicle 40. More specifically, the second or rearward of the two fan units 14 shown in FIG. 6 is arranged higher from the roof of vehicle 40 than the first or forward of the two fan units 14. Preferably, the wedge slopes upward from the front to the rear of vehicle 40 as this configuration is more efficient when vehicle 40 is being driven forward. Specifically, this configuration is advantageous in that it also provides for a more aerodynamic shape to power system 10 and as such is able to lower the added drag force of power system 10 on vehicle 40.

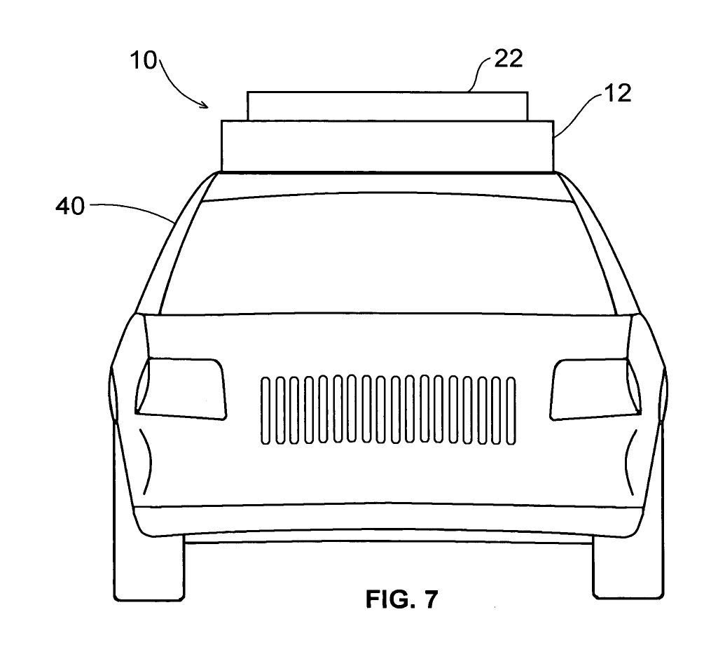

Referring now to FIG. 7, a front view of one embodiment of the invention 10 is shown showing a flat design, meaning that two or more fan units are in generally the same horizontal plane. As can be seen, in this configuration, power system 10 has a relatively low profile, which can be preferred for smaller vehicles or vehicles themselves having a lower profile design.

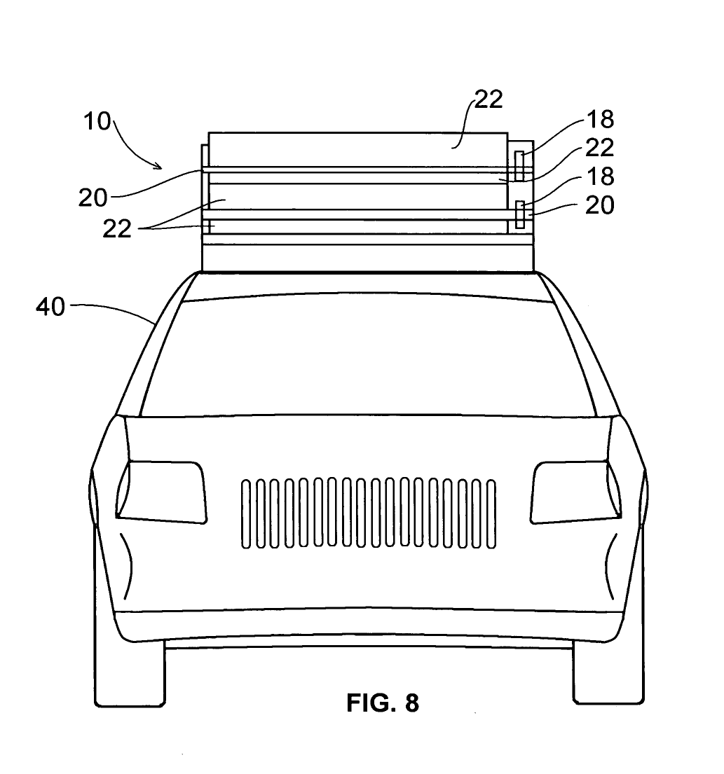

Referring now to FIG. 8, a front view of another embodiment of the invention 10 is shown showing a wedge design, meaning that two or more fan units 14 are in different horizontal planes, but preferably are in the same sloped plane relative to the top of vehicle 40. As can be seen, in this configuration, power system 10 has a larger profile, which can be preferred for larger vehicles or vehicles themselves having a higher profile design.

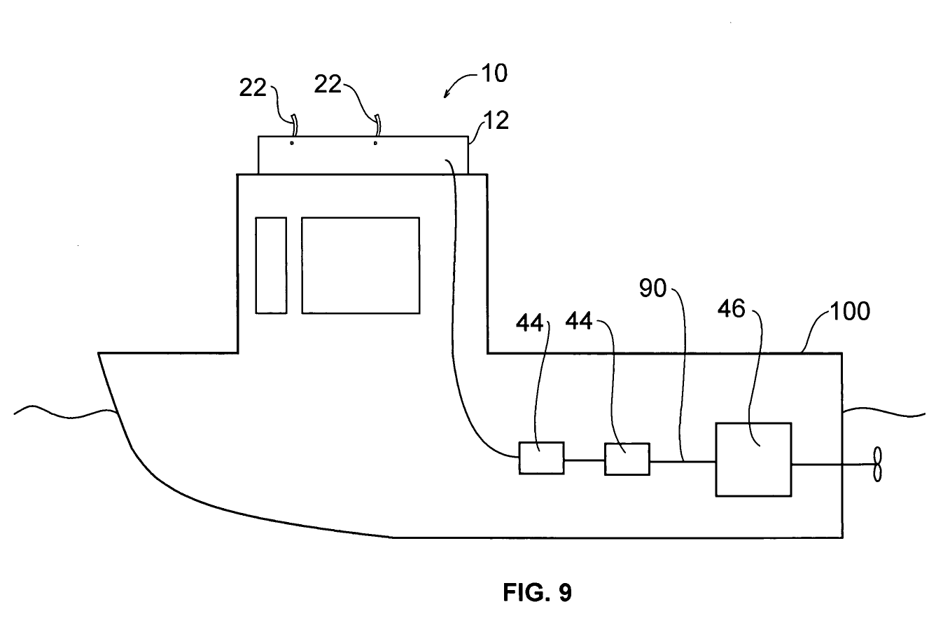

Referring now to FIG. 9, a side view of an embodiment of the invention 10 mounted on a watercraft 100 is shown. The use of the invention 10 on watercraft 100, or other types of craft, illustrates the versatility of the invention 10.

Power system 10 can have a closing mechanism (not shown) the top of support structure 12 to prevent air, precipitation, and debris from entering support structure and possibly adversely affecting fan units 14 and electric alternators 16. Further, a closing mechanism can be used to reduce the drag force of power system 10 when the user decides that it is inappropriate or unnecessary to use power system 10, such as when the gasoline only mode of a hybrid engine 46 is used, or when vehicle 40 is parked. Such a closing mechanism can be a simple mechanical gating member.

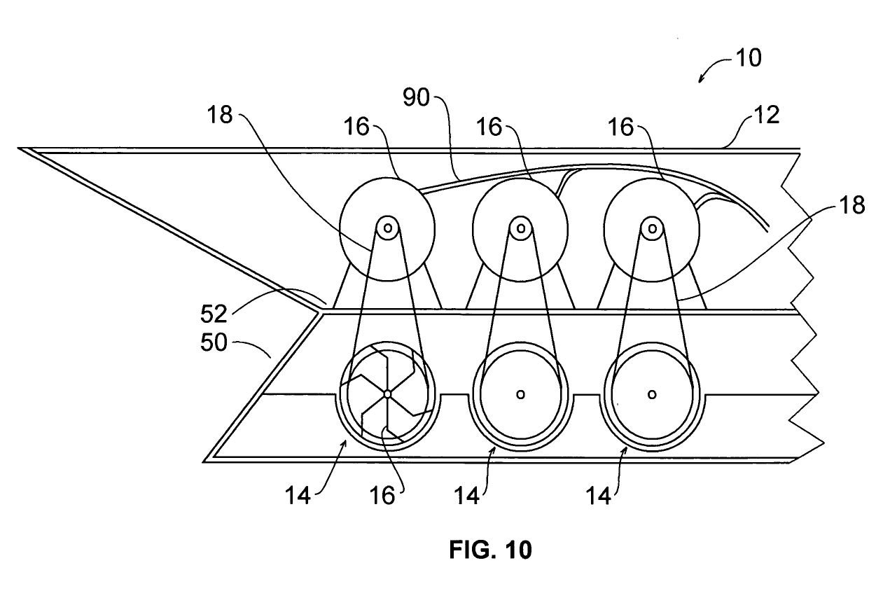

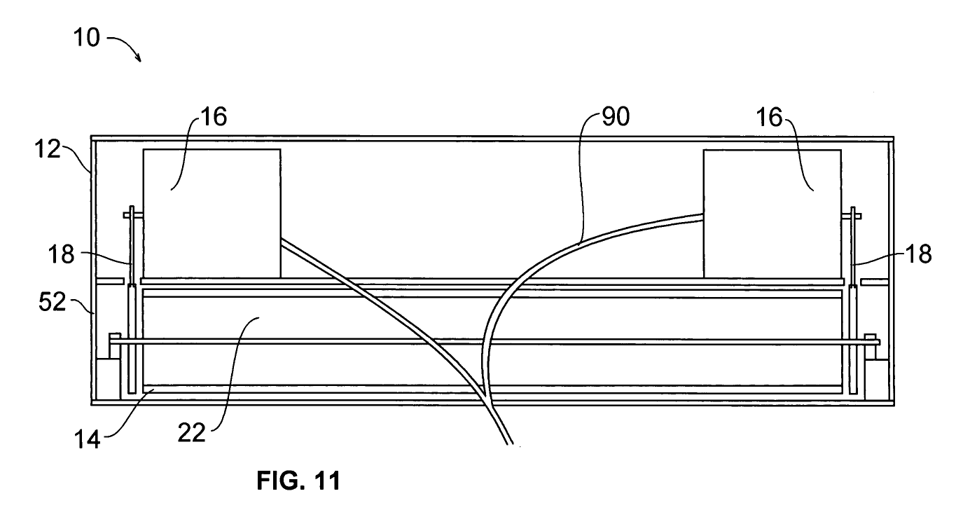

Referring now to FIG. 10, an over-under embodiment of the power system 10 is shown. The primary components of the invention remain the same, however the structure of the support structure 12 and the placement of the components within the support structure 12 are varied. Specifically, alternators 16 are mounted over fan units 14, either on the sides of support structure 12 or on a central platform 52. While this configuration can increase the overall height of the device, it also allows there to be more fan units 14 and generators 16 per linear unit of length. Also shown in FIG. 10 is a cone 50 for directing air or water across the fan blades 22. A front view of the over-under embodiment is shown in FIG. 11.

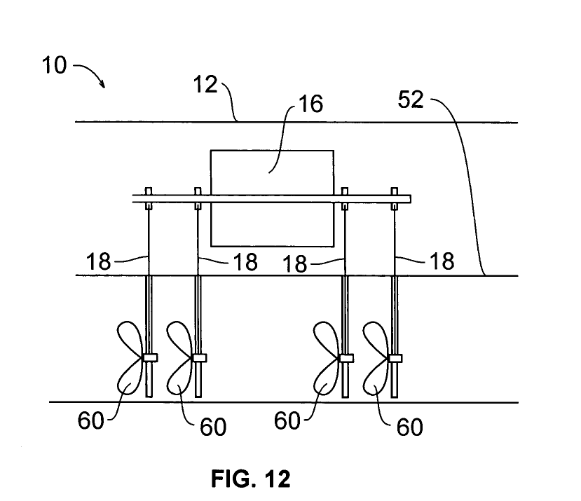

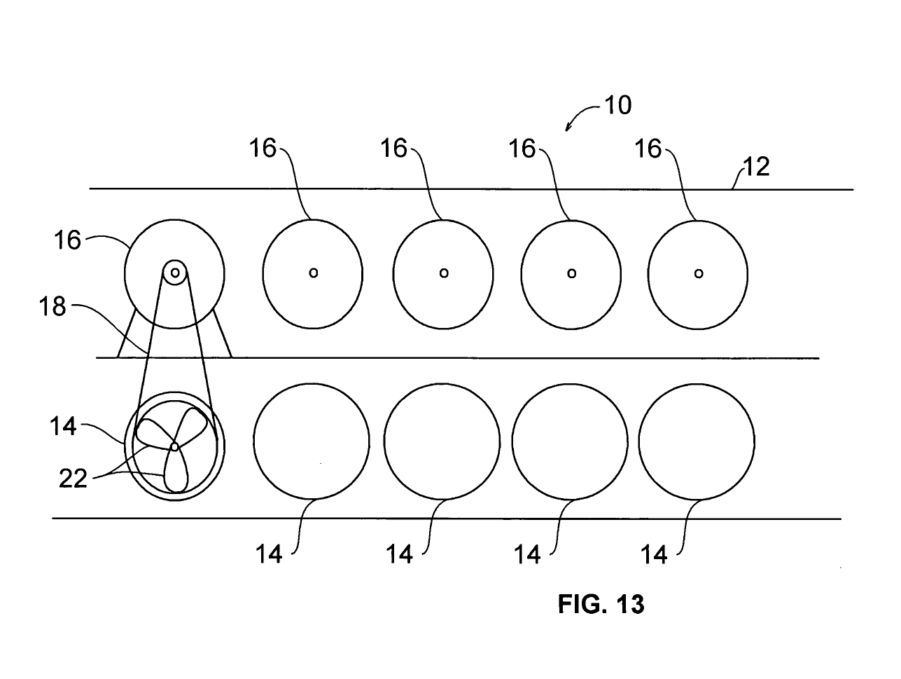

Referring now to FIG. 12, a propeller-type fan blade embodiment of the power system 10 is shown. In this embodiment, a series of propellers 60 are mounted generally coaxially or on parallel axes with each other and with alternator 16. Any number of propellers 60 can be used for each alternator. Also in this embodiment, the fan unit 14 and alternator 16 combinations are more compact and can be lined up side by side when viewed from the front of the vehicle. Although FIG. 12 shows alternators 16 mounted above fan units 14, the mounting configuration can be varied. For example, fan units 14 and alternators can share a common axis and be mounted linearly. A front view of the propeller 60 fan blade embodiment is shown in FIG. 13.

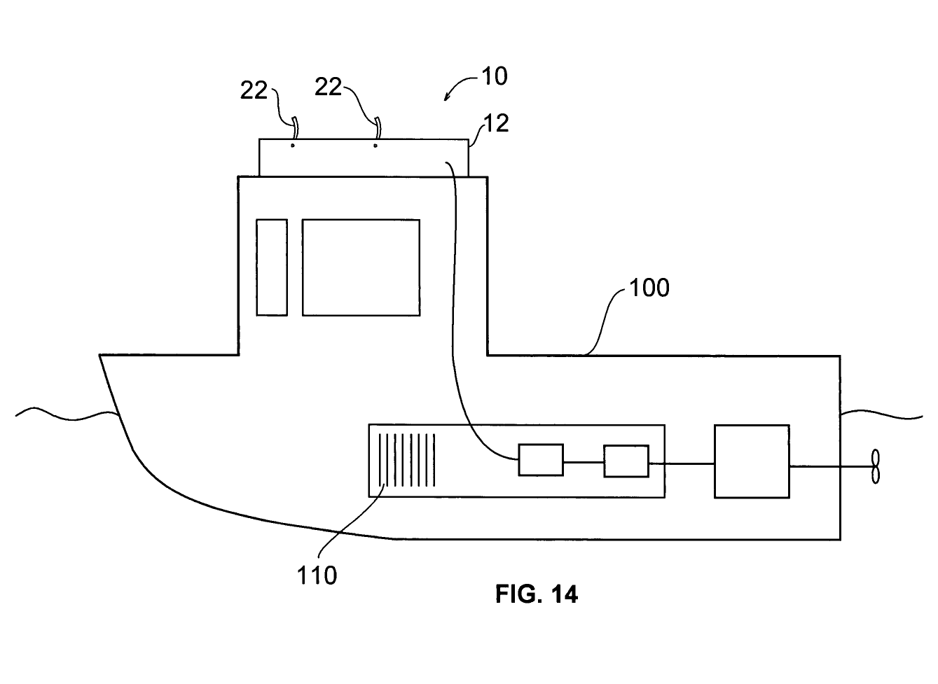

Referring now to FIG. 14, an alternate embodiment of power system 10 mounted on a watercraft 100 is shown. In this embodiment, watercraft 100 comprises both an airflow power system 10 as shown in FIG. 9 and a waterflow power system 110. The waterflow power system 110 is mounted on the side of watercraft 110 below the waterline and takes advantage of water currents. Structurally, waterflow power system 110 is comparable to the airflow power systems 10 disclosed above, but preferably includes waterproof components and suitable seals to prevent water damage to power system 110 and water infiltration to watercraft 100. More specifically, fan units 14 can be physically separated from alternators 16, with fan units 14 being on the outside of watercraft 100 for contacting water currents, and alternators 16 being on the inside of watercraft 100 where they can be kept dry. Various suitable means of connecting outside fan units 14 to inside alternators 16 are known and can be used.

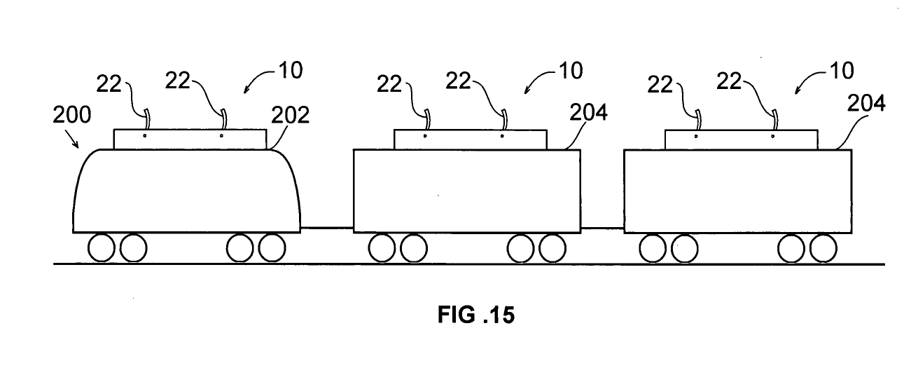

Referring now to FIG. 15, an alternate embodiment of power system 10 is shown as mounted on a train 200. The structure and function of power system 10 as shown in this embodiment is comparable to the power system 10 disclosed above. Power system 10 can be mounted on the train locomotive 202 and/or on the train cars 204 and electrically wired to the train engine or batteries.

In operation and use, the combination of fan units 14 and electric alternators 16 produce electrical energy for vehicle 40 as the air or water flows across and rotates fan units 14. When facing into the air or water currents or when vehicle 40 moves forward, air or water flows across fan units 14 causing fan blades 22 to rotate. As the air or water presses against fan blades 22 extending out of support structure 12, fan units 12 rotate about central axes 20, turn fan belts 18, thus transferring the rotational energy to electric alternators 16. Rotating electric alternators 16 thus generate energy that will charge battery 42 or power engine 46 to run vehicle 40. Because fan blades 22 within support structure 12 preferably are not exposed to the air or water, air or water can only press against fan blades 22 extending out of support structure 12. By only allowing the air or water to press against fan blades 12 extending out of support structure 12, the efficiency of the power system 12 is improved.

Power system 10 can be connected to batteries 44 and engine 46 in a relatively simple circuit. For example, the circuit can be a series circuit comprising batteries 44, alternators 16, and engine 46. Optionally, the circuit can also comprise a voltage regulator. One of ordinary skill in the art can integrate power system 10 into the circuitry of ordinary vehicle 40 during production or post-production without undue experimentation. The connections between electric alternators 16 and batteries 44 and engine 46 can be made through conventional wires 90 and voltage regulating means. In one embodiment, the voltage regulating means can adjust to different voltages that are generated by fan units 14 and can vary with different speeds of vehicle 40.

The drag force created by the placement of power system 10 upon vehicle 40 preferably is designed to be minimal. For example, in the air-power system 10, fan unit 14 should not be excessively high is as this will increase the drag force. Similarly, fan unit 14 should not be too low, as this will minimize the surface area available to the fan blades 22, which can make power generation more difficult. By limiting the size of fan unit 14, one of ordinary skill in the art can avoid increasing substantially the drag force on vehicle 40.

Vehicle 40 may be parked facing into the direction of the air or water currents so to provide a means for charging, recharging, or supplementing the charging battery 44 when vehicle 40 is stationary. As vehicle 40 is parked, the generated electric energy can be used to charge batteries 44 or may be used to power useful devices such as a radio or other ancillary device. Alternatively for example, if vehicle 40 is a refrigerated delivery truck, the generated power can be used to power the refrigerating mechanism. Thus, the fan units 14 provide a means for providing electricity for useful functions when the engine 46 is not in use.

As disclosed, once the electrical energy has been produced, it is possible to use the energy for an array of purposes. While these embodiments have been described as the alternative source of energy for vehicle 40, it is understood that power system 10 can be used main source of power for vehicle 40 or as a reserve source of power for vehicle 40. More particularly, power system 10 can serve a reserve source of power, which can be used when vehicle 40 is not moving or when vehicle 40 is out of other types of fuel. Further, in other cases, power system 10 can charging or recharging other backup fuel cells. In other cases, the energy can be used to power vehicle accessories.

While power system 10 has been described primarily in connection with automobiles, it is understood that power system 10 can be used with an array of land, sea and air vehicles. Such land vehicles include trains, trucks, trailers, buses, and motor homes. Such sea vehicles include boats, ships, and the like. Such air vehicles include jets, propeller-driven aircraft, ultra-lights, and gliders. One of ordinary skill in the art can equip such vehicles with the present invention without undue experimentation.

The above detailed description of the preferred embodiments and the appended figures are for illustrative purposes only and are not intended to limit the scope and spirit of the invention, and its equivalents, as defined by the appended claims. One skilled in the art will recognize that many variations can be made to the invention disclosed in this specification without departing from the scope and spirit of the invention.

1. A power system for powering a vehicle comprising at least one fan unit and at least one electric alternator associated with the at least one fan unit, wherein:
a) the at least one fan unit comprises a central axis and at least one fan blade;
b) the at least one fan blade extends axially from and spans substantially the length of the central axis; and
c) the at least one fan unit is mounted on the vehicle laterally across at least a portion of the vehicle.

2. The system as claimed in claim 1, further comprising at least two fan units.

3. The system as claimed in claim 1, wherein the system powers the electrical systems of the vehicle.

4. The system as claimed in claim 1, further comprising at least two electric alternators associated with each of the fan units.

5. The system as claimed in claim 2, wherein the at least two fan units are positioned one behind the other.

6. The system as claimed in claim 5, wherein the at least two fan units are located in the same horizontal plane.

7. The system as claimed in claim 5, wherein the at least two fan units are located in different horizontal planes.

8. The system as claimed in claim 7, wherein the at least two fan units are located in the same sloped plane.

9. The system as claimed in claim 8, wherein the sloped plane slopes upwards from the front of the vehicle to the back of the vehicle.

10. The system as claimed in claim 1, wherein each fan unit further comprises at least three fan blades.

11. The system as claimed in claim 10, wherein the fan blades are concave.

12. The system as claimed in claim 10, wherein the fan blades are curved at the ends.

13. The system as claimed in claim 1, wherein the central axis is perpendicular to a centerline extending from the front of the vehicle to the back of the vehicle.

14. The system as claimed in claim 13, wherein the fan unit comprises a plurality of fan blades and fewer than the plurality of fan blades are contacted by a driving force at any given time and position.

15. The system as claimed in claim 14, wherein the driving force is selected from the group consisting of airflow and waterflow.

16. A combination of an at least partially electrically powered vehicle and a power system for powering the vehicle, the power system comprising at least one fan unit and at least one electric alternator associated with the at least one fan unit, wherein:
a) the at least one fan unit comprises a central axis and at least one fan blade;
b) the at least one fan blade extends axially from and spans substantially the length of the central axis; and
c) the at least one fan unit is mounted on the vehicle laterally across at least a portion of the vehicle.

17. The combination as claimed in claim 16, wherein the power system further comprises at least two fan units.

18. The combination as claimed in claim 16, wherein the power system powers the electrical systems of the vehicle.

19. The combination as claimed in claim 16, wherein the power system further comprises at least two electric alternators associated with each of the fan units.

20. The combination as claimed in claim 17, wherein the power system further comprises at least two fan units are position one behind the other.

21. The combination as claimed in claim 20, wherein the at least two fan units are located in the same horizontal plane.

22. The combination as claimed in claim 20, wherein the at least two fan units are located in different horizontal planes.

23. The combination as claimed in claim 22, wherein the at least two fan units are located in the same sloped plane.

24. The combination as claimed in claim 23, wherein the sloped plane slopes upwards from the front of the vehicle to the back of the vehicle.

25. The combination as claimed in claim 16, wherein each fan unit further comprises at least three fan blades.

26. The combination as claimed in claim 16, wherein the vehicle contains a hybrid gasoline and electrically driven engine.

27. The system as claimed in claim 25, wherein the fan blades are concave.

28. The system as claimed in claim 25, wherein the fan blades are curved at the ends.

29. The system as claimed in claim 16, wherein the central axis of the power system is perpendicular to a centerline extending from the front of the vehicle to the back of the vehicle.

30. The system as claimed in claim 29, wherein the fan unit comprises a plurality of fan blades and fewer than the plurality of fan blades are contacted by a driving force at any given time and position.

31. The system as claimed in claim 30, wherein the driving force is selected from the group consisting of airflow and waterflow.

32. A power system for powering a vehicle comprising at least two fan units and two electric alternators associated with each of the at least one fan units, wherein:
a) the at least two fan units each comprise a central axis and at least three fan blades;
b) the at least three fan blades extend axially from and span substantially the length of the central axis; and
c) the at least one fan unit is mounted on the vehicle laterally across at least a portion of the vehicle.

33. The system as claimed in claim 32, wherein the at least two fan units are positioned one behind the other.

34. The system as claimed in claim 33, wherein the at least two fan units are located in the same horizontal plane.

35. The system as claimed in claim 33, wherein the at least two fan units are located in different horizontal planes.

36. The system as claimed in claim 35, wherein the at least two fan units are located in the same sloped plane sloping upwards from the front of the vehicle to the back of the vehicle.

37. The system as claimed in claim 33, wherein the fan blades are concave.

38. The system as claimed in claim 33, wherein the fan blades are curved at the ends.

39. The system as claimed in claim 32, wherein the central axis is perpendicular to a centerline extending from the front of the vehicle to the back of the vehicle.

40. The system as claimed in claim 39, wherein the fan unit comprises a plurality of fan blades and fewer than the plurality of fan blades are contacted by a driving force at any given time and position.

41. The system as claimed in claim 40, wherein the driving force is selected from the group consisting of airflow and waterflow.

42. A combination of an at least partially electrically powered vehicle and a power system for powering the vehicle, the power system comprising at least two fan units and two electric alternators associated with each of the at least one fan units, wherein:
a) the at least two fan units each comprise a central axis and at least three fan blades;
b) the at least three fan blades extend axially from and span substantially the length of the central axis; and
c) the at least one fan unit is mounted on the vehicle laterally across at least a portion of the vehicle.

43. The combination as claimed in claim 42, wherein the at least two fan units are positioned one behind the other.

44. The combination, as claimed in claim 43, wherein the at least two fan units are located in the same horizontal plane.

45. The combination as claimed in claim 43, wherein the at least two fan units are located in different horizontal planes.

46. The combination as claimed in claim 45, wherein the at least two fan units are located in the same sloped plane sloping upwards from the front of the vehicle to the back of the vehicle.

47. The system as claimed in claim 42, wherein the fan blades are concave.

48. The system as claimed in claim 42, wherein the fan blades are curved at the ends.

49. The system as claimed in claim 42, wherein the central axis is perpendicular to a centerline extending from the front of the vehicle to the back of the vehicle.

50. The system as claimed in claim 49, wherein the fan unit comprises a plurality of fan blades and fewer than the plurality of fan blades are contacted by a driving force at any given time and position.

51. The system as claimed in claim 50, wherein the driving force is selected from the group consisting of airflow and waterflow.
